(19) United States
(12) Patent Application Publication
(10) Pub. No.: US 2023/0177716 A1
(43) Pub. Date: Jun. 8, 2023

(54) INFORMATION PROCESSING DEVICE, NON-TRANSITORY COMPUTER-READABLE STORAGE MEDIUM, AND INFORMATION PROCESSING METHOD

(71) Applicant: Mitsubishi Electric Corporation, Tokyo (JP)

(72) Inventor: Keiichi TSUDA, Tokyo (JP)

(73) Assignee: Mitsubishi Electric Corporation, Tokyo (JP)

(21) Appl. No.: 17/921,371

(22) PCT Filed: May 11, 2020
(86) PCT No.: PCT/JP2020/018770

§ 371 Date: Oct. 26, 2022

(51) Int. Cl. G06T 7/70; G06V 10/25; G06V 10/75; G06V 10/74; G06V 10/764

(52) U.S. Cl. CPC G06T 7/70; G06V 10/25; G06V 10/758; G06V 10/761; G06V 10/764; G06V 2201/07; G06T 2207/20084; G06T 2207/20101

(57) ABSTRACT

Provided is a second-part-position estimating unit (120) that calculates a plurality of second-part estimated positions by estimating a position of a second part in a target image from a plurality of first-part position candidates, each of which is a candidate of a position of a first part in the target image; and a first-part-position-candidate confidence-level calculating unit (130) that calculates a plurality of first-part-position candidate confidence levels indicating confidence levels of the first-part position candidates so that the longer the distance between a second-part position, which is the position of the second part in the target image, and one of the second-part estimated positions, the lower the confidence level of the first-part position candidate used for the estimation of the one of the second-part estimated position out of the first-part position candidates.

### TECHNICAL FIELD

The disclosure relates to an information processing device, a program, and an information processing method.

### BACKGROUND ART

Conventionally, a technique for estimating a posture through the detection of parts of a skeletal frame or the like. For example, the technique disclosed in Patent Literature 1 includes multiple stages of detectors constructed by a neural network for the respective skeletal parts to be detected. All of the first-stage detectors operate independently, and the subsequent-stage detectors are improved in detection accuracy as a whole by unidirectionally or bidirectionally using the detection results of the first stage for a skeletal part different from that detected by the first-stage detectors.

### PRIOR ART REFERENCE

### Patent Reference

Patent Literature 1: WO 2017/166019

### SUMMARY OF THE INVENTION

### Problem to be Solved by the Invention

However, the conventional technique has a problem in that since the exchange of information between multiple detectors is established by the neuron connection of a neural network, the content of the information input and output between the detectors is unknown to humans, and the implementation of detectors in a framework other than the neural network is difficult.

Accordingly, it is an object of one or more aspects of the disclosure to enable the calculation of the confidence level of first-part position candidates by using the position of a second part, with or without the use of a neural network.

### Means of Solving the Problem

An information processing device according to a first aspect of the disclosure includes: a second-part-position estimating unit configured to calculate a plurality of second-part estimated positions by estimating a position of a second part in a target image from a plurality of first-part position candidates, each of the first-part position candidates being a candidate of a position of a first part in the target image; and a first-part-position-candidate confidence-level calculating unit configured to calculate a plurality of first-part-position candidate confidence levels indicating confidence levels of the first-part position candidates so that the longer the distance between a second-part position and one of the second-part estimated positions, the lower the confidence level of the first-part position candidate used for the estimation of the one of the second-part estimated position out of the first-part position candidates, the second-part position being a position of the second part in the target image.

An information processing device according to a second aspect of the disclosure includes: a second-part-position estimating unit configured to calculate a plurality of second-part estimated positions by estimating a position of a second part in a target image from a plurality of first-part position candidates, each of the first-part position candidates being a candidate of a position of a first part in the target image; and a first-part-position-candidate confidence-level calculating unit configured to calculate a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image; calculate a second confidence level of each of the first-part position candidates so that the longer the distance between a first-part estimated position estimated to be a position of the first part in the target image and one of the first-part position candidates, the lower the confidence level of the one of the first-part position candidates; and calculate a plurality of first-part-position candidate confidence levels each of which indicates the confidence level of each of the first-part position candidates by weighting and adding the first confidence level and the second confidence level of each of the first-part position candidates.

An information processing device according to a third aspect of the disclosure includes: a second-part-position estimating unit configured to calculate a plurality of second-part estimated positions by estimating a position of a second part in a target image from a plurality of first-part position candidates, each of the first-part position candidates being a candidate of a position of a first part in the target image; and a first-part-position-candidate confidence-level calculating unit configured to calculate a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image; calculate a second confidence level of each of the first-part position candidates so that the longer the distance between a first-part delay position selected to be a position of the first part in the past and one of the first-part position candidates, the lower the confidence level of the one of the first-part position candidates; and calculate a plurality of first-part-position candidate confidence levels each of which indicates the confidence level of each of the first-part position candidates by weighting and adding the first confidence level and the second confidence level of each of the first-part position candidates.

An information processing device according to a fourth aspect of the disclosure includes a second-part-position estimating unit configured to calculate a plurality of second-part estimated positions by estimating a position of a second part in a target image from a plurality of first-part position candidates, each of the first-part position candidates being a candidate of a position of a first part in the target image; and a first-part-position-candidate confidence-level calculating unit configured to calculate a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image; calculate a second confidence level of each of the first-part position candidates so that the longer the distance between a second-part delay position used as the second-part position in the past and one of the second-part estimated positions, the lower the confidence level of the first-part position candidate used for the estimation of the one of the second-part estimated positions; and calculate a plurality of first-part-position candidate confidence levels each of which indicates the confidence level of each of the first-part position candidates by weighting and adding the first confidence level and the second confidence level of each of the first-part position candidates.

A program according to a first aspect of the disclosure causes a computer to function as: a second-part-position estimating unit configured to calculate a plurality of second-part estimated positions by estimating a position of a second part in a target image from a plurality of first-part position candidates, each of the first-part position candidates being a candidate of a position of a first part in the target image; and a first-part-position-candidate confidence-level calculating unit configured to calculate a plurality of first-part-position candidate confidence levels indicating confidence levels of the first-part position candidates so that the longer the distance between a second-part position and one of the second-part estimated positions, the lower the confidence level of the first-part position candidate used for the estimation of the one of the second-part estimated position out of the first-part position candidates, the second-part position being a position of the second part in the target image.

A program according to a second aspect of the disclosure causes a computer to function as: a second-part-position estimating unit configured to calculate a plurality of second-part estimated positions by estimating a position of a second part in a target image from a plurality of first-part position candidates, each of the first-part position candidates being a candidate of a position of a first part in the target image; and a first-part-position-candidate confidence-level calculating unit configured to calculate a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image; calculate a second confidence level of each of the first-part position candidates so that the longer the distance between a first-part estimated position estimated to be a position of the first part in the target image and one of the first-part position candidates, the lower the confidence level of the one of the first-part position candidates; and calculate a plurality of first-part-position candidate confidence levels each of which indicates the confidence level of each of the first-part position candidates by weighting and adding the first confidence level and the second confidence level of each of the first-part position candidates.

A program according to a third aspect of the disclosure causes a computer to function as: a second-part-position estimating unit configured to calculate a plurality of second-part estimated positions by estimating a position of a second part in a target image from a plurality of first-part position candidates, each of the first-part position candidates being a candidate of a position of a first part in the target image; and a first-part-position-candidate confidence-level calculating unit configured to calculate a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image; calculate a second confidence level of each of the first-part position candidates so that the longer the distance between a first-part delay position selected to be a position of the first part in the past and one of the first-part position candidates, the lower the confidence level of the one of the first-part position candidates; and calculate a plurality of first-part-position candidate confidence levels each of which indicates the confidence level of each of the first-part position candidates by weighting and adding the first confidence level and the second confidence level of each of the first-part position candidates.

A program according to a fourth aspect of the disclosure causes a computer to function as: a second-part-position estimating unit configured to calculate a plurality of second-part estimated positions by estimating a position of a second part in a target image from a plurality of first-part position candidates, each of the first-part position candidates being a candidate of a position of a first part in the target image; and a first-part-position-candidate confidence-level calculating unit configured to calculate a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image; calculate a second confidence level of each of the first-part position candidates so that the longer the distance between a second-part delay position used as the second-part position in the past and one of the second-part estimated positions, the lower the confidence level of the first-part position candidate used for the estimation of the one of the second-part estimated positions; and calculate a plurality of first-part-position candidate confidence levels each of which indicates the confidence level of each of the first-part position candidates by weighting and adding the first confidence level and the second confidence level of each of the first-part position candidates.

An information processing method according to a first aspect of the disclosure includes: calculating a plurality of second-part estimated positions by estimating a position of a second part in a target image from a plurality of first-part position candidates, each of the first-part position candidates being a candidate of a position of a first part in the target image; and calculating a plurality of first-part-position candidate confidence levels indicating confidence levels of the first-part position candidates so that the longer the distance between a second-part position and one of the second-part estimated positions, the lower the confidence level of the first-part position candidate used for the estimation of the one of the second-part estimated position out of the first-part position candidates, the second-part position being a position of the second part in the target image.

An information processing method according to a second aspect of the disclosure includes: calculating a plurality of second-part estimated positions by estimating a position of a second part in a target image from a plurality of first-part position candidates, each of the first-part position candidates being a candidate of a position of a first part in the target image; calculating a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image; calculating a second confidence level of each of the first-part position candidates so that the longer the distance between a first-part estimated position estimated to be a position of the first part in the target image and one of the first-part position candidates, the lower the confidence level of the one of the first-part position candidates; and calculating a plurality of first-part-position candidate confidence levels each of which indicates the confidence level of each of the first-part position candidates by weighting and adding the first confidence level and the second confidence level of each of the first-part position candidates.

An information processing method according to a third aspect of the disclosure includes: calculating a plurality of second-part estimated positions by estimating a position of a second part in a target image from a plurality of first-part position candidates, each of the first-part position candidates being a candidate of a position of a first part in the target image; calculating a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image; calculating a second confidence level of each of the first-part position candidates so that the longer the distance between a first-part delay position selected to be a position of the first part in the past and one of the first-part position candidates, the lower the confidence level of the one of the first-part position candidates; and calculating a plurality of first-part-position candidate confidence levels each of which indicates the confidence level of each of the first-part position candidates by weighting and adding the first confidence level and the second confidence level of each of the first-part position candidates.

An information processing method according to a fourth aspect of the disclosure includes: calculating a plurality of second-part estimated positions by estimating a position of a second part in a target image from a plurality of first-part position candidates, each of the first-part position candidates being a candidate of a position of a first part in the target image; calculating a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image; calculating a second confidence level of each of the first-part position candidates so that the longer the distance between a second-part delay position used as the second-part position in the past and one of the second-part estimated positions, the lower the confidence level of the first-part position candidate used for the estimation of the one of the second-part estimated positions; and calculating a plurality of first-part-position candidate confidence levels each of which indicates the confidence level of each of the first-part position candidates by weighting and adding the first confidence level and the second confidence level of each of the first-part position candidates.

### Effects of the Invention

According to one or more aspects of the disclosure, the confidence level of first-part position candidates can be calculated by using the position of a second part, with or without the use of a neural network.

### BRIEF DESCRIPTION OF THE DRAWINGS

FIG. 1 is a block diagram schematically illustrating the configuration of a detection device according to first, sixth, and seventh embodiments.

FIGS. 2A to 2D are schematic diagrams for explaining a target image, first-part position candidates, second-part estimated positions, and the confidence level of first-part position candidates.

FIG. 3 is a block diagram illustrating an example configuration of a second-part-position estimating unit using SVR.

FIG. 4 is a schematic diagram illustrating an example of classification.

FIG. 5 is a graph illustrating the confidence level.

FIGS. 6A and 6B are block diagrams illustrating hardware configuration examples.

FIG. 7 is a block diagram schematically illustrating the configuration of a detection device according to a second embodiment.

FIGS. 8A to 8D are schematic diagrams for explaining the operation of first-part position candidate detection.

FIG. 9 is a block diagram illustrating the overall configuration of a first example of a detection device serving as a skeletal detection device.

FIG. 10 is a block diagram schematically illustrating the configuration of a detection device according to a third embodiment.

FIG. 11 is a schematic diagram for explaining the detection operation of a first-part-position candidate detecting unit.

FIG. 12 is a block diagram illustrating the overall configuration of a second example of a detection device serving as a skeletal detection device.

FIG. 13 is a block diagram schematically illustrating the configuration of a detection device according to a fourth embodiment.

FIG. 14 is a block diagram schematically illustrating the configuration of a detection device according to a fifth embodiment.

FIGS. 15A to 15F are schematic diagrams illustrating a method of determining the class to which learning data belongs according to a sixth embodiment.

FIG. 16 is a schematic diagram illustrating example distribution of feature values in a feature value space.

FIG. 17 is a schematic diagram illustrating a method of determining the class to which learning data belongs according to a seventh embodiment.

### MODE FOR CARRYING OUT THE INVENTION

The embodiments will be described below.

The term “part” in the following embodiments refers to a skeletal part such as a human shoulder or elbow, which is a part constituting a skeletal frame. A skeletal part may be a human joint site or a site other than a human joint (for example, an ear or an eyes). Alternatively, a skeletal part may be a site constituting the skeletal frame of a non-human animal. Alternatively, the term “part” may refer to a machine part such as a link in a robot.

### First Embodiment

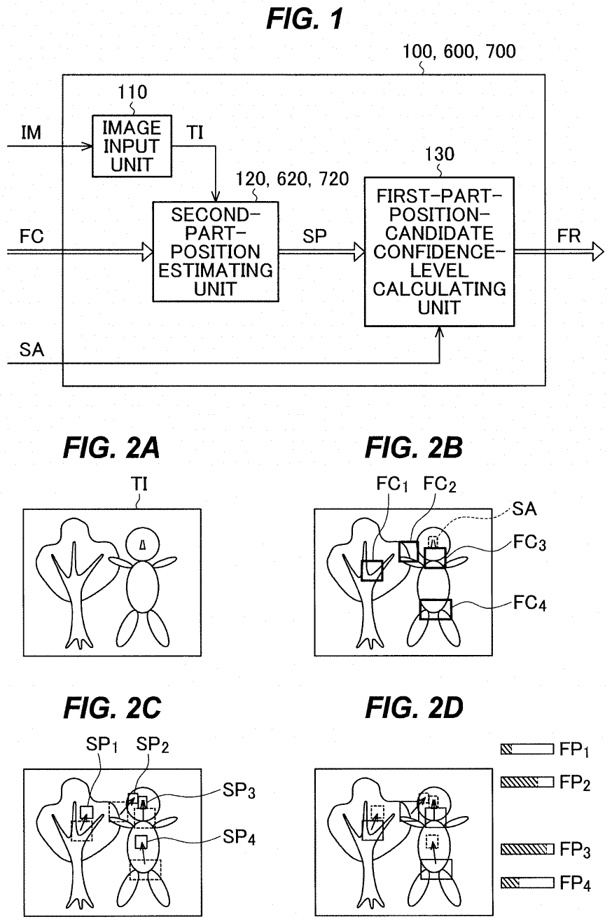

FIG. 1 is a block diagram schematically illustrating the configuration of a detection device 100 serving as an information processing device according to the first embodiment. In the drawing, single line arrows and double line arrows are illustrated, and the double line arrows indicate that multiple inputs and outputs are allowed in one process.

The detection device 100 includes an image input unit 110, a second-part-position estimating unit 120, and a first-part-position-candidate confidence-level calculating unit 130.

The detection device 100 according to the first embodiment is described as a skeletal-frame detection device for detecting a human skeletal frame.

The image input unit 110 is an input interface for accepting input of images IM. The image input unit 110 then gives each of the input images IM to the second-part-position estimating unit 120 as a target image TI. The target image TI may be a two-dimensional image or a three-dimensional image such as a distance image or point group information.

For example, the image input unit 110 may accept input of the images IM from an imaging device such as a two-dimensional still camera or a three-dimensional still camera that can capture still images in real time. Alternatively, the image input unit 110 may accept input of the images IM from an image capturing device such as a two-dimensional camcorder or a three-dimensional camcorder that can capture moving images. Alternatively, the image input unit 110 may accept input of the images IM by receiving the transfer of still images or moving images recorded on a storage medium such as a disk, a tape, or a flash memory.

When an image IM input to the image input unit 110 is a still image, the image input unit 110 gives the image IM directly to the subsequent stage as a target image TI. When an image IM is a moving image, the image input unit 110 gives the frames of the moving image in sequence to the subsequent stage as target images TI. For example, FIG. 2A illustrates an example target image TI.

The second-part-position estimating unit 120 estimates a second-part estimated position SP from a target image TI and a first-part position candidate FC. The first-part position candidate FC may be one candidate or two or more candidates. This is indicated by the double line arrow denoted by FC in FIG. 1, and other double line arrows also indicate the same.

When multiple first-part position candidates FC are input to the second-part-position estimating unit 120, the second-part-position estimating unit 120 estimates second-part estimated positions SP corresponding to the respective candidates. In other words, the number of the first-part position candidates FC is the same as the number of the second-part estimated positions SP.

In other words, the second-part-position estimating unit 120 calculates multiple second-part estimated positions SP by estimating the position of the second part in the target image TI from each of the first-part position candidates FC, which are the candidates of the position of the first part in the target image TI. As an example, the second-part-position estimating unit 120 calculates multiple second-part estimated positions SP from corresponding first-part position candidates FC and vectors calculated by adding learning-data difference vectors corresponding to preliminarily classified classes to which the first-part position candidates FC belong in accordance with the likelihood of the first-part position candidates FC belonging to the classes.

For example, FIG. 2B illustrates an example of first-part position candidates FC.

FIG. 2B illustrates four first-part position candidates FC₁ to FC₄.

In FIGS. 2B to 2D, the first-part position candidates FC are represented as rectangles. Here, the first-part position candidates FC are each illustrated by adding the height and width of a rectangle to the x and y coordinate values in the screen. The coordinates indicating the position corresponding to the x and y coordinates may indicate the center of the rectangle or any one of the vertices of the rectangle.

Alternatively, a first-part position candidate FC may be represented by a square or a single point. For example, a first-part position candidate FC may be represented by only the x and y coordinate values in the screen. Alternatively, a first-part position candidate FC may be represented by adding the dimension of a side of the region to the x and y coordinate values in the screen. The coordinate indicating the position corresponding to the x and y coordinates may indicate the center of a square or any one of the vertices of the square.

A second-part position SA, which is the actual position of the second part, is input to the detection device 100, but the second-part-position estimating unit 120 calculates a second-part estimated position SP without referring to the second-part position SA.

In the first embodiment, the first part is the neck and the second part is the nose. That is, the second-part-position estimating unit 120 receives the neck position as a first-part position candidate FC and outputs the estimated position of the nose as a second-part estimated position SP.

The second-part-position estimating unit 120 can specify a second-part estimated position SP by using, for example, a method using a neural network, a method using a support vector machine (SVM) or support vector regression (SVR), a method using regression analysis, or a method using a genetic algorithm or genetic programming.

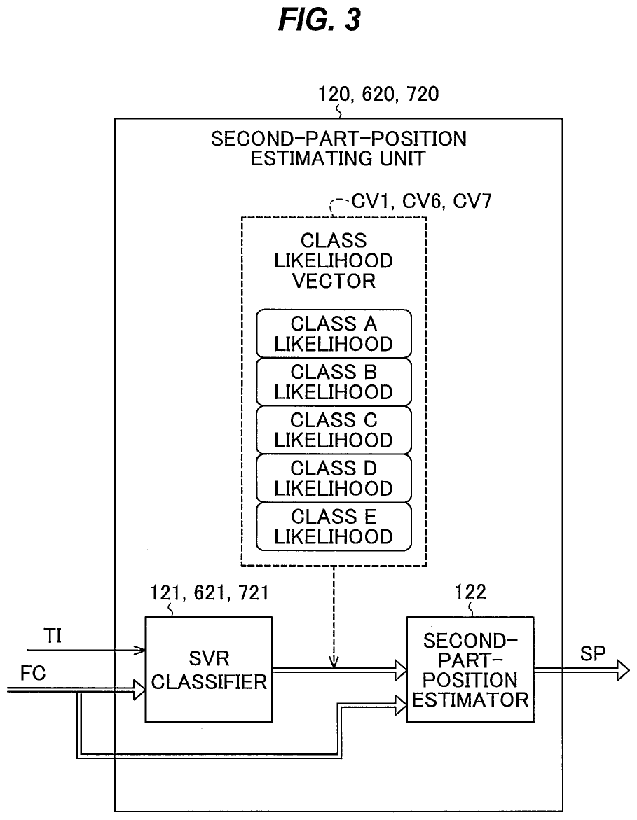

FIG. 3 is a block diagram illustrating an example configuration of the second-part-position estimating unit 120 using SVR.

The second-part-position estimating unit 120 includes an SVR classifier 121 and a second-part-position estimator 122.

The SVR classifier 121 uses SVR to analyze a portion of the target image TI corresponding to a first-part position candidate FC, specifies a class likelihood vector CV1, and gives the class likelihood vector CV1 to the second-part-position estimator 122.

The class likelihood vector CV1 is a vector indicating the likelihood of the portion corresponding to the first-part position candidate FC belonging to each of predetermined classes. With the class likelihood vector CV1, it is presumed that the sum of the likelihoods of all classes is one.

When multiple first-part position candidates FC are input, the SVR classifier 121 outputs multiple class likelihood vectors CV1 corresponding to these first-part position candidates FC.

SVR has a function of constructing a model from a large volume of pre-recorded learning data, classifying the input in accordance with the model, and outputting the likelihood of each class. Since the detailed design and implementation are outside the scope of the first embodiment, they will not be described here.

The learning data is usually converted to some kind of feature value before the model is constructed. The feature values commonly used include feature values of histograms of oriented gradients (HOG), local binary patterns (LBP), Haar-Like features, and scale invariant feature transform (SIFT); any of these feature values can be applied to the present embodiment.

In the first embodiment, the learning data is classified into several classes at the time of the SVR model construction. Since the purpose of this is to estimate the position of an adjacent part, which is a part adjacent to a certain part, the classes are defined such that the characteristics (specifically, the direction in which the part exists) of the adjacent part are different for each class.

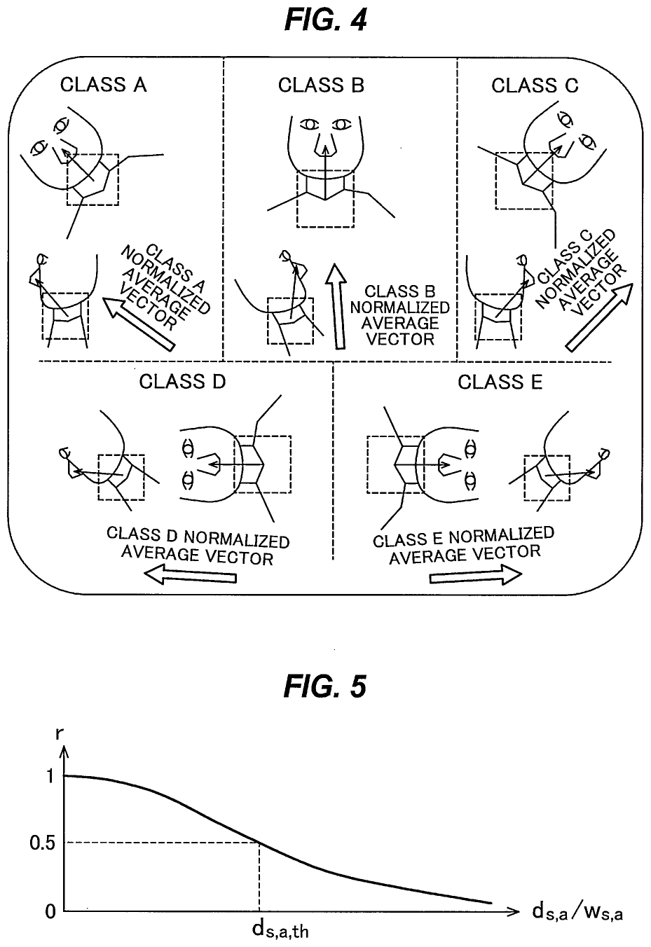

FIG. 4 is a schematic diagram illustrating a first example of classification.

FIG. 4 illustrates an example of classification into five classes, classes A to E.

In the example illustrated in FIG. 4, the classification of each of the five classes is based on a different direction of the vector from a certain part to an adjacent part, in this case, the vector from the position where a neck exists to the position where the nose exists.

The class A, illustrated in FIG. 4, is a collection of images of the neck in which the nose is positioned in the upper left direction relative to the neck. The class B is a collection of images of the neck in which the nose is positioned in the upper direction relative to the neck. The class C is a collection of images of the neck in which the nose is positioned in the upper right direction relative to the neck. The class D is a collection of images of the neck in which the nose is positioned in the left direction relative to the neck. The class E is a collection of images of the neck in which the nose is positioned in the right direction relative to the neck.

For example, a nose-part learning image group is a pre-recorded nose-part image group, a neck-part learning image group is a pre-recorded neck-part image group, and a learning-data difference vector represents the difference between the coordinates corresponding to the position of a part (the nose, in this case) selected from the nose-part learning image group and the coordinates corresponding to the position of a corresponding part (the neck, in this case) in the neck-part learning image group. In such a case, the classification can be based on the direction of the learning-data difference vector.

When the learning data is classified, an average or a variance may be calculated with respect to statistical data of the relationship between the position of the nose and the position of the neck, that is, the length, direction, or the like of the learning-data difference vectors. As for the length, since it is presumed that the usual dimension of a side of the nose region is substantially proportional to the distance from the camera to the nose, it is also presumed that the distance between the neck and the nose is substantially proportional to the distance from the camera to the neck, i.e., the dimension of a side of the neck region. Thus, a statistics value normalized by dividing the learning-data difference vector by the dimension of a side of the neck region may be used. In FIG. 4, a normalized average vector from the neck to the nose for the learning data of each class is preliminarily calculated. It is presumed here that the nose position and the neck position are each represented by a square.

The classification illustrated in FIG. 4 is an example, and classification by other strategies may be performed, such as classification including a downward direction or a diagonally downward direction or classification using a three-dimensional angle in place of a two-dimensional angle in a screen by obtaining three-dimensional information when learning data is acquired.

Referring back to FIG. 3, the second-part-position estimator 122 calculates a second-part estimated position SP from the class likelihood vector CV1 and the first-part position candidate FC, and outputs the second-part estimated position SP. For example, the second-part-position estimator 122 calculates the second-part estimated position SP by obtaining the weighted-average of the normalized average vector from the neck to the nose of each class obtained during learning by using the value indicated by the likelihood vector.

When the statistics value is divided by the dimension of a side of the neck region to obtain the average during the statistic calculation, the second-part-position estimator 122 needs to multiply the dimension of the side of the detected neck region by the normalized average vector. In other words, the positional relationship between the neck as the first part and the nose as the second part changes in accordance with the dimensions of the first part in the target image TI. The second-part-position estimator 122 calculates the second-part estimated position SP by adding the weighted average vector obtained in this way and the first-part position candidate FC.

FIG. 2C illustrates an example of the second-part estimated positions SP.

In FIG. 2C, the second-part estimated positions SP₁ to SP₃ are represented by rectangles, but alternatively they may be squares or single points as the first-part position candidates FC. FIG. 2C illustrates four second-part estimated positions SP₁ to SP₄ corresponding to the four first-part position candidates FC₁ to FC₄.

As described above in the first embodiment, the classes are preliminarily classified on the basis of the direction of the learning-data difference vectors, when a pre-recorded first part group or first learning part group has parts corresponding to the respective first parts, a second part group or second learning part group has pre-recorded parts corresponding to the respective second parts, and a learning-data difference vector represents the difference between a coordinate value of a part in the first learning part group and a coordinate value of a part in the second learning part group which corresponds to the part in the first learning part group. The second-part estimated positions SP are each calculated on the basis of the likelihood that the corresponding first-part position candidate FC belongs to each of the classes and the statistics value of the learning-data difference vector for each of the classes.

Referring back to FIG. 1, the first-part-position-candidate confidence-level calculating unit 130 calculates first-part-position candidate confidence levels FR, which are the confidence levels of the first-part position candidates FC, by using the second-part estimated positions SP and the second-part position SA. As described above, the number of the second-part estimated positions SP is the same as the number of the first-part position candidates FC. The number of the first-part-position candidate confidence levels FR is also the same as the number of the first-part position candidates FC.

For example, the first-part-position-candidate confidence-level calculating unit 130 calculates multiple first-part-position candidate confidence levels FR indicating the confidence levels of the first-part position candidates FC so that the longer the distance between the second-part position SA, which is the position of the second part in the target image TI, and one of the second-part estimated positions SP, the lower the confidence level of the first-part position candidate FC used for the estimation of the second-part estimated position SP out of the multiple first-part position candidates FC.

FIG. 2B illustrates an example of a second-part position SA.

In FIG. 2B, the second-part position SA is represented by a rectangle, but alternatively, the second-part position SA may be represented by a square or a point, as in the first-part position candidates FC.

FIG. 2D illustrates first-part-position candidate confidence levels FR.

FIG. 2D illustrates four first-part-position candidate confidence levels FR₁ to FR₄ corresponding to first-part position candidates FC₁ to FC₄.

It should be noted here that the validity of the second-part estimated positions SP is tied to the confidence level as a first part, not to the confidence level as a second part. This is because the second-part estimated positions SP₁ to SP₄ are derived from the first-part position candidates FC₁ to FC₄, respectively. That is, it is considered that a second-part estimated position SP estimated from a region appropriate as a first-part position candidate FC is close to the actual position of the second part.

The first-part-position-candidate confidence-level calculating unit 130 makes a calculation so that a first-part-position candidate confidence level FR of a first-part-position candidate FC corresponding to a second-part estimated position SP close to the second-part position SA becomes high. If the second-part estimated position SP and the second-part position SA each includes not only the x and y coordinates of them but also the dimension of a side or the height or width of them, the first-part-position-candidate confidence-level calculating unit 130 can also take into account the gap in calculating the confidence level.

A specific example of a calculation formula for the first-part-position candidate confidence level FR will be provided below.

When the distance between a second-part estimated position SP and a second-part position SA is d_{s,a} pixels, the dimension of a side of the second-part position SA is W_{s,a} pixels, and a threshold predetermined by the designer is d_{s,a,th}, the first-part-position candidate confidence level FR or confidence level r can be determined by Equation (1) below.

$$[ Equation 1 ]$$

$$r = exp ( - \frac{( {d}_{s , a} / {w}_{s , a} )}{1.4427 {d}_{s , a , th}} ) \qquad ( 1 )$$

The constant 1.4427 is set to achieve r=0.5 when d_{s,a,th}=d_{s,a}/W_{s,a}. In other words, the constant 1.4427 is a multiplier that allows d_{s,a,th} to be intuitively adjusted. Therefore, even if the constant 1.4427 is not provided, there is essentially no problem.

FIG. 5 is a graph illustrating the relationship between d_{s,a}/W_{s,a} and r.

Equation (1) is a Gaussian function, and enables adjustment of the degree of attenuation of the confidence level r with the value of d_{s,a,th}.

As illustrated in FIG. 5, the constant 1.4427 allows intuitive understanding that when the confidence level r is greater than 0.5, d_{s,a}/W_{s,a} is smaller than the threshold d_{s,a,th}, and when the confidence level r is 0.5 or greater, d_{s,a}/W_{s,a} is greater than or equal to the threshold d_{s,a,th}.

Equation (1) is an example in which the second-part estimated position SP and the second-part position SA are squares.

When the second-part estimated position SP and the second-part position SA are rectangles, W_{s,a} is the average of the long side and the short side of the second-part position SA.

When each of the second-part estimated position SP and the second-part position SA is coordinates of a point, W_{s,a} may be set to “1.”

When neither the second-part estimated position SP nor the second-part position SA is coordinates of a point, it is possible to use Equation (2) below to take into account the gap between the dimensions of the second-part estimated position SP and the second-part position SA, where the dimension of a side of the second-part estimated position SP is W_{s,p} pixels.

$$[ Equation 2 ]$$

$$r = exp ( - \frac{( {d}_{s , a} / {w}_{s , a} )}{1.4427 {d}_{s , a , th}} ) \frac{min ( {w}_{s , a} , {w}_{s , p} )}{max ( {w}_{s , a} , {w}_{s , p} )} \qquad ( 2 )$$

Here, min(w_{s,a}, w_{s,p}) indicates that the smaller of w_{s,a} and w_{s,p} is used, and max(w_{s,a},w_{s,p}) indicates that the larger of w_{s,a} and w_{s,p} is used.

When the second-part estimated position SP and the second-part position SA are rectangles, W_{s,p} is the average of the long side and the short side of the second-part estimated position SP.

When Equation (2) is used, and w_{s,a}=w_{s,p}, the value of the confidence level r is the same as that determined by Equation (1), but the greater the gap between w_{s,a} and w_{s,p}, that is, the greater the misestimation of the dimensions, the lower the confidence level r determined by Equation (2).

The equations presented here are mere examples, and the confidence level may be calculated using an exponential function, a trigonometric function, a logarithmic function, a hyperbolic function, a step function, a delta function, or other mathematical functions including a first-order polynomial, a second-order polynomial, a higher-order polynomial, a square root or a cube root, or a mathematical formula combining these functions.

As described above, an example of the benefit of using the first-part-position candidate confidence level FR, which is output from the detection device 100 according to the first embodiment, is being able to select just one position candidate from the multiple first-part position candidates FC. In a simplest example, the position candidate having the highest confidence level is selected. In another example, other conditions are combined to select just one position candidate. A specific example of this will be described in the second embodiment.

As described above, another example of the benefit of using the first-part-position candidate confidence level FR, which is output from the detection device 100 according to the first embodiment, is being able to reject a first-part position candidate FC. That is, when there is a position candidate having a first-part-position candidate confidence level FR equal to or lower than a certain value in the first-part position candidates FC, this position candidate can be deleted from the first-part position candidates to suppress the selection of an uncertain first-part position candidate FC, that is, erroneous detection.

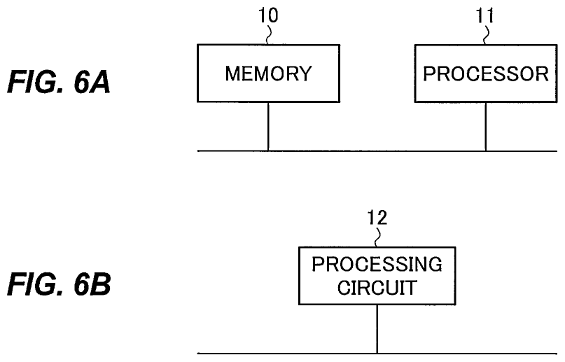

A portion or the entirety of the image input unit 110, the second-part-position estimating unit 120, and the first-part-position-candidate confidence-level calculating unit 130 described above can be implemented by, for example, a memory 10 and a processor 11, such as a CPU, that executes the programs stored in the memory 10, as illustrated in FIG. 6A. In other words, the detection device 100 may be implemented by a computer. Such programs may be provided via a network or may be recorded and provided on a recording medium. That is, such programs may be provided as, for example, program products.

A portion or the entirety of the image input unit 110, the second-part-position estimating unit 120, and the first-part-position-candidate confidence-level calculating unit 130 can be implemented by, for example, a processing circuit 12, such as a single circuit, a composite circuit, a programmed processor, a parallel programmed processor such as a graphics processing unit (GPU), an application-specific integrated circuit (ASIC), or a field programmable gate array (FPGA), as illustrated in FIG. 6B.

In other words, the image input unit 110, the second-part-position estimating unit 120, and the first-part-position-candidate confidence-level calculating unit 130 can be implemented by processing circuitry.

### Second Embodiment

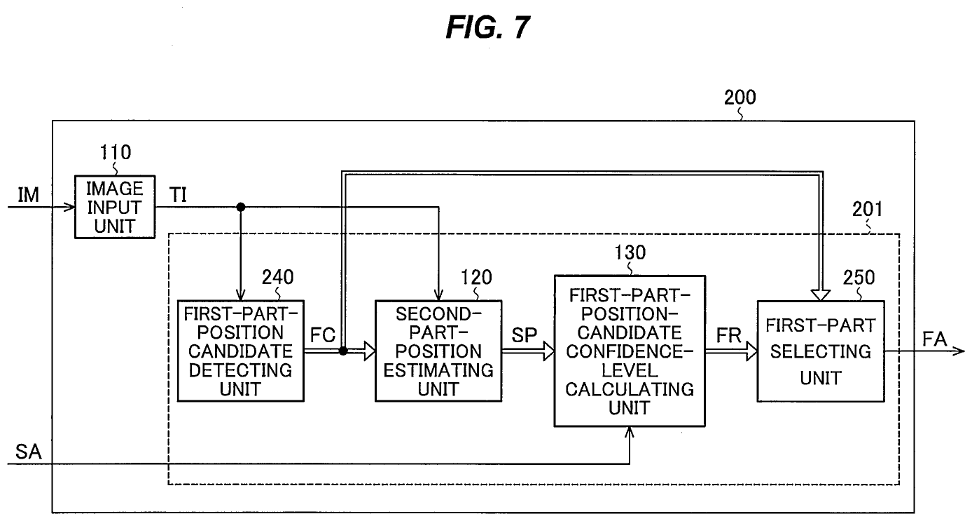

FIG. 7 is a block diagram schematically illustrating the configuration of a detection device 200 according to the second embodiment.

The detection device 200 includes an image input unit 110, a first-part-position candidate detecting unit 240, a second-part-position estimating unit 120, a first-part-position-candidate confidence-level calculating unit 130, and a first-part selecting unit 250.

The image input unit 110, the second-part-position estimating unit 120, and the first-part-position-candidate confidence-level calculating unit 130 of the detection device 200 according to the second embodiment are respectively the same as the image input unit 110, the second-part-position estimating unit 120, and the first-part-position-candidate confidence-level calculating unit 130 of the detection device 100 according to the first embodiment.

However, the image input unit 110 according to the second embodiment gives a target image TI to the first-part-position candidate detecting unit 240 and the second-part-position estimating unit 120. The second-part-position estimating unit 120 receives a first-part position candidate FC from the first-part-position candidate detecting unit 240. The first-part-position-candidate confidence-level calculating unit 130 gives a first-part-position candidate confidence level FR to the first-part selecting unit 250.

The first-part-position candidate detecting unit 240 detects a first-part position candidate FC from the target image TI. Multiple candidates are allowed as the first-part position candidates FC, as in the first embodiment.

The function of the first-part-position candidate detecting unit 240 will now be described with reference to an example in which the first part is the neck.

The first-part-position candidate detecting unit 240 specifies a first-part position candidate FC from the target image TI by using a cascade detector, an SVM detector, a detector by a random forest, a detector by a genetic algorithm (GA), a detector by genetic programming (GP), a detector by a neural network, or the like. Since these methods are known, they will not be described here, and a method of detection using a cascade detector will now be described as an example.

As illustrated in FIG. 7, the target image TI is given to the cascade detector or the first-part-position candidate detecting unit 240.

It is presumed that a learning model is preliminarily constructed from a large volume of learning data in the cascade detector or the first-part-position candidate detecting unit 240 to select a first-part candidate region or a neck candidate region. Since the construction method is known, it will not be described here.

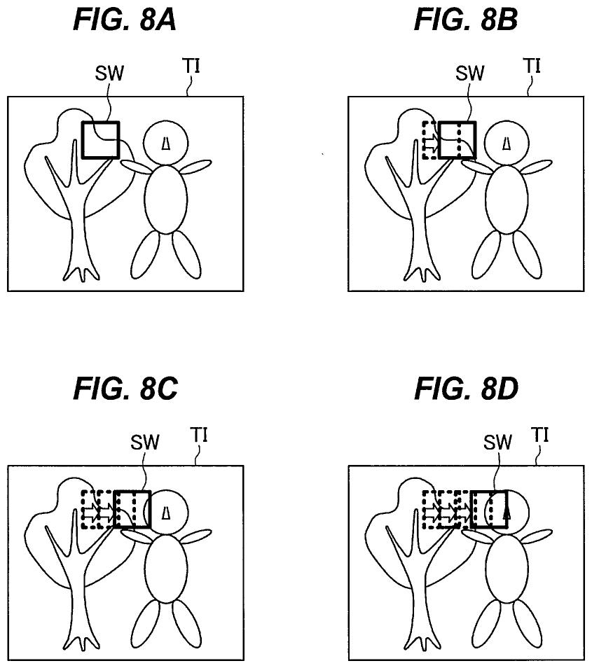

As illustrated in FIGS. 8A to 8D, the cascade detector or the first-part-position candidate detecting unit 240 detects whether or not a partial image clipped from the target image TI by a sliding window SW being gradually shifted meets the conditions indicated by the learning model, in other words, whether the partial image is suitable as a neck candidate region.

A typical cascade detector can also be applied to multi-scale detection, in which case the cascade detector or the first-part-position candidate detecting unit 240 searches the neck candidate region as the size of the sliding window SW is also being changed.

The cascade detector or the first-part-position candidate detecting unit 240 gives a variable number of first-part position candidates FC detected through such processing to the second-part-position estimating unit 120 and the first-part selecting unit 250.

Referring back to FIG. 7, the first-part selecting unit 250 selects one first-part position candidate FC from the first-part position candidates FC provided by the first-part-position candidate detecting unit 240 in accordance with the first-part-position candidate confidence levels FR, and outputs the selected first-part position candidate FC as a first-part position FA. The first-part position FA may be a single point, a rectangle, or a square, like the first-part position candidates FC and the like.

The first-part selecting unit 250 may select, for example, the first-part position candidate FC having the highest first-part-position candidate confidence level FR.

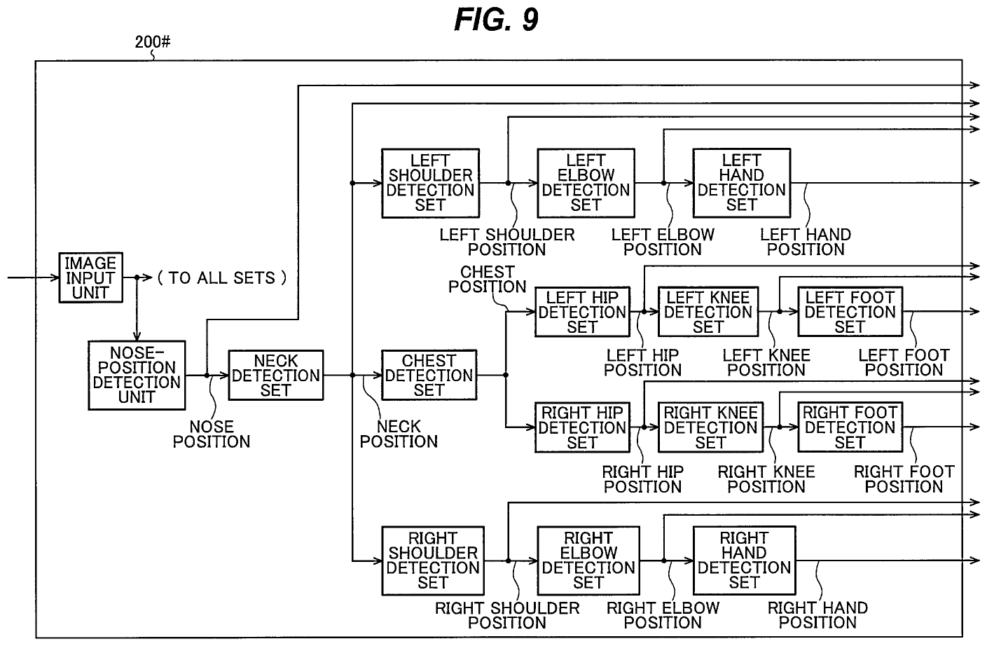

FIG. 9 illustrates an example of the overall configuration of a detection device 200 # serving as a skeletal detection device that performs the processing by the detection device 200 illustrated in FIG. 7 on all parts to be detected in a human skeletal frame.

Here, each block illustrated in FIG. 9 including a character string “set”, such as “neck detection set,” “right shoulder detection set,” “chest detection set,” or “left shoulder detection set,” is constituted by a part output device 201 indicated by the dashed lines in FIG. 7.

Specifically, the part output device 201 including the first-part-position candidate detecting unit 240, the second-part-position estimating unit 120, the first-part-position-candidate confidence-level calculating unit 130, and the first-part selecting unit 250 can receive the first-part position FA output from a preceding set or a nose-coordinate detection unit as a second-part position SA, to output the position of a desired part as the first-part position FA.

In other words, a part detection set represented by a block can accurately select and output the position of the corresponding site by using the confidence level based on the difference between the estimated value and the actual value of a preceding site.

The “nose-position detection unit,” which is the leading block, can be implemented by using the same function as that of the first-part-position candidate detecting unit 240.

In FIG. 9, the parts to be detected are listed as “nose,” “neck,” “right shoulder,” “right elbow,” “right hand,” “left shoulder,” “left elbow,” “left hand,” “chest,” “right hip,” “right knee,” “right foot,” “left hip,” “left knee,” and “left foot” in a detection order considered appropriate, but such combination and detection order of the parts are mere examples and do not preclude insertion of other parts, skipping of some parts, or changing of the detection order.

Such a detection device 200 # can accurately detect the entire human skeletal frame.

An example of a benefit of using the output of the detection device 200 # according to the second embodiment having the above-described configuration is human behavior detection. For example, it is possible to detect a motion by a passenger searching for a document placed on a seat next to the passenger from a detection result obtained from an image of the compartment of a passenger car. Alternatively, the presence of a person trying to get into an elevator can be detected from the detection result obtained from an image of the front of the elevator.

Another example of the use of the output of the detection device 200 # is cooperation between robots. In specific, a robot can detect the state of the arm of another robot and use only images to perform a task such as handing over an object while avoiding collision of their arms.

The detection device 200 illustrated in FIG. 7 may include only one of the first-part-position candidate detecting unit 240 and the first-part selecting unit 250.

A portion or the entirety of the image input unit 110, the first-part-position candidate detecting unit 240, the second-part-position estimating unit 120, the first-part-position-candidate confidence-level calculating unit 130, and the first-part selecting unit 250 described above can be implemented by, for example, a memory 10 and a processor 11, such as a CPU, that executes the programs stored in the memory 10, as illustrated in FIG. 6A. In other words, the detection device 200 may be implemented by a computer. Such programs may be provided via a network or may be recorded and provided on a recording medium. That is, such programs may be provided as, for example, program products.

A portion or the entirety of the image input unit 110, the first-part-position candidate detecting unit 240, the second-part-position estimating unit 120, the first-part-position-candidate confidence-level calculating unit 130, and the first-part selecting unit 250, for example, can be implemented by the processing circuit 12, as illustrated in FIG. 6B.

In other words, the image input unit 110, the first-part-position candidate detecting unit 240, the second-part-position estimating unit 120, the first-part-position-candidate confidence-level calculating unit 130, and the first-part selecting unit 250 can be implemented by processing circuitry.

### Third Embodiment

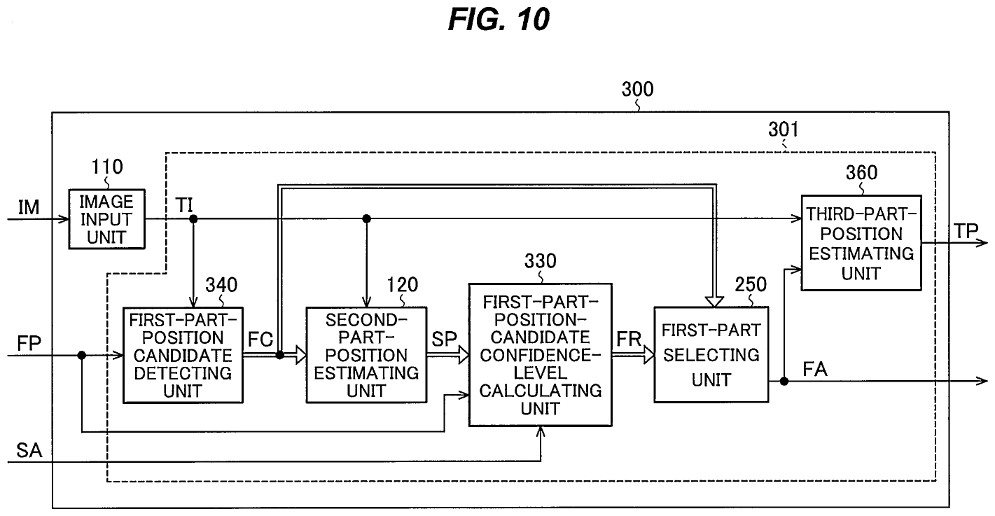

FIG. 10 is a block diagram schematically illustrating the configuration of a detection device 300 according to the third embodiment.

The detection device 300 includes an image input unit 110, a first-part-position candidate detecting unit 340, a second-part-position estimating unit 120, a first-part-position-candidate confidence-level calculating unit 330, a first-part selecting unit 250, and a third-part-position estimating unit 360.

The image input unit 110 and the second-part-position estimating unit 120 of the detection device 300 according to the third embodiment are respectively the same as the image input unit 110 and the second-part-position estimating unit 120 of the detection device 100 according to the first embodiment.

However, the image input unit 110 according to the third embodiment gives a target image TI to the first-part-position candidate detecting unit 340, the second-part-position estimating unit 120, and the third-part-position estimating unit 360. The second-part-position estimating unit 120 receives a first-part position candidate FC from the first-part-position candidate detecting unit 340 and gives a second-part estimated position SP to the first-part-position-candidate confidence-level calculating unit 330.

The first-part selecting unit 250 of the detection device 300 according to the third embodiment is the same as the first-part selecting unit 250 of the detection device 200 according to the second embodiment.

However, the first-part selecting unit 250 receives a first-part-position candidate confidence level FR from the first-part-position-candidate confidence-level calculating unit 330 and gives a first-part position FA to the third-part-position estimating unit 360.

The first-part-position candidate detecting unit 340 specifies a first-part position candidates FC from the target image TI and a first-part estimated position FP. Multiple candidates are allowed as the first-part position candidates FC, as in the first embodiment. In addition to the x and y coordinates, a square or a rectangle is also allowed as the first-part estimated position FP, like the second-part estimated position SP, etc. An input “no estimated position” is also permitted as the first-part estimated position FP.

The function of the first-part-position candidate detecting unit 340 will now be described with reference to an example in which the first part is the neck.

The function of the first-part-position candidate detecting unit 340 is substantially the same as that of the first-part-position candidate detecting unit 240 of the second embodiment. For example, the first-part-position candidate detecting unit 340 detects a first-part position candidate FC from a target image TI and a first-part estimated position FP by using a cascade detector, an SVM detector, a detector by a random forest, a detector by a GA, a detector by GP, a detector by a neural network, or the like. Since these methods are known, they will not be described here, and a method of detection using a cascade detector will now be described as an example.

A first-part estimated position FP is input to the first-part-position candidate detecting unit 340 according to the third embodiment. Through the use of the first-part estimated position FP, the detection speed and the detection accuracy can be improved.

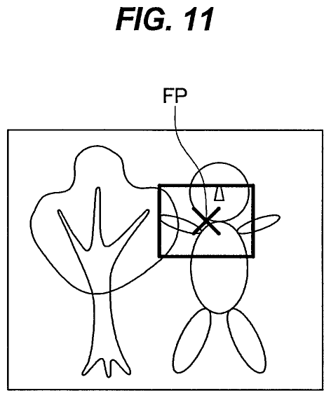

FIG. 11 is a schematic diagram for explaining the detection operation by the first-part-position candidate detecting unit 340.

As illustrated in FIG. 11, a first-part estimated position FP indicating the neck is provided, and the search range of the cascade detector is limited to the area around the first-part estimated position FP indicating the neck. The cascade detector determines whether or not an area corresponding to the sliding window SW is appropriate as the neck as the sliding window SW is gradually shifted for search, as illustrated in FIG. 8. In such a case, the number of determinations can be reduced by limiting the search range as illustrated in FIG. 11, and the detection speed can be improved. Also, by suppressing false detection outside the search range, accuracy can be improved.

When multi-scale search is performed, the same effect can be achieved by suppressing the validity determination based on sliding windows having sizes that greatly deviate from the estimated size. That is, the detection speed is improved by the reduction in the number of determinations, and the detection accuracy is improved by the suppression of erroneous detection of a neck region that greatly deviates from the estimated size.

In addition, a similar effect can be achieved by reducing the sliding width of the sliding window in an area close to the first-part estimated position FP, which is the neck, and increasing the sliding width in an area far from the first-part estimated position FP.

As described above in the third embodiment, the first-part-position candidate detecting unit 340 can specify a partial region (the search range) of the target image TI by using the first-part estimated position FP, which is the estimated position of the first part, and can detect a first-part position candidate FC from the specified region.

Note that the size of the search range may be any predetermined size. For example, the size may be fixed regardless of the type of the first part, or the size may be predetermined for each type of the first part.

Alternatively, the size of the search range may be variable. For example, the first-part estimated position FP may include not only its position but also variation, e.g., a variance covariance matrix, and the size may be determined on the basis of such value. For example, when the variance in the x-axis direction is vₓₓ and the variance in the y-axis direction is v_{yy}, the search size along the x-axis may be a value obtained by multiplying the square root of vₓₓ by two, and the search size along the y-axis may be a value obtained by multiplying the square root of v_{yy} by two.

When “no estimated position” is input to the first-part-position candidate detecting unit 340 as the first-part estimated position FP, the entire target image TI may be set as the search range; in such a case, the above-mentioned advantages may not be achieved, but the search itself can be executed.

Referring back to FIG. 10, the first-part-position-candidate confidence-level calculating unit 330 will now be described.

In the first embodiment, the first-part-position candidate confidence level FR is calculated in accordance with the gap between the second-part estimated position SP and the second-part position SA, but in the third embodiment, the first-part-position candidate confidence level FR can be calculated by also using the gap between the first-part position candidate FC and the first-part estimated position FP.

A specific example of a calculation formula for the first-part-position candidate confidence level FR will be provided below. When the distance between the first-part position candidate and the first-part estimated position is denoted by d_{f,p}, the dimension of a side of the first-part estimated position is denoted by w_{f,p}, the distance threshold used for the first part determined by the designer is denoted by d_{f,p,th}, the weight of the confidence level by the second part determined by the designer is denoted by g_{s,a}, and the weight of the confidence level by the first part determined by the designer is denoted by g_{f,p}, the confidence level r can be determined by Equation (3) below.

$$[ Equation 3 ]$$

$$r = {g}_{s , a} exp ( - \frac{( {d}_{s , a} / {w}_{s , a} )}{1.4427 {d}_{s , a , th}} ) + {g}_{f , p} exp ( - \frac{( {d}_{f , p} / {w}_{f , p} )}{1.4427 {d}_{f , p , th}} ) \qquad ( 3 )$$

The first term on the right side of Equation (3) is the same as that in Equation (1) of the first embodiment except that the weight value g_{s,a} is a multiplier. The second term is also calculated by the same Gaussian function as that used for the first term, except that the target part of the distance calculation is changed from the second part to the first part, and the actual position used in the first term is replaced by an estimated position.

Equation (3) is an example in which the first-part position candidate FC and the first-part estimated position FP are squares.

When the first-part position candidate FC and the first-part estimated position FP are rectangles, W_{f,p} denotes the average of the long side and the short side of the first-part estimated position FP.

When each of the first-part position candidate FC and the first-part estimated position FP is coordinates of a point, W_{f,p} may be set to “1.”

When neither the first-part position candidate FC nor the first-part estimated position FP is the coordinates of a point, Equation (4) below can be used by introducing the same idea as Equation (2) in which the gap of the size of part is also taken into account.

$$[ Equation 4 ]$$

$$\begin{matrix}r = {g}_{s , a} exp ( - \frac{( {d}_{s , a} / {w}_{s , a} )}{1.4427 {d}_{s , a , th}} ) \frac{min ( {w}_{s , a} , {w}_{s , p} )}{max ( {w}_{s , a} , {w}_{s , p} )} \\ + {g}_{f , p} exp ( - \frac{( {d}_{f , p} / {w}_{f , p}}{1.4427 {d}_{f , p , th}} ) \frac{min ( {w}_{f , p} , {w}_{f , c} )}{max ( {w}_{f , p} , {w}_{f , c} )}\end{matrix} \qquad ( 4 )$$

Where w_{f,c} is the dimension of a side of the first-part position candidate FC.

When the first-part position candidate FC and the first-part estimated position FP are rectangles, W_{f,c} is the average of the long side and the short side of the first-part position candidate FC.

As described above, the first-part-position-candidate confidence-level calculating unit 330 according to the third embodiment calculates multiple first confidence levels (the first term on the right side of Equation (3) or Equation (4)) of the first-part position candidates FC so that the longer the distance between the second-part position SA, which is the position of the second part in the target image TI, and one of the second-part estimated positions SP, the lower the confidence level of the first-part position candidate FC used for the estimation of the second-part estimated position SP out of the multiple first-part position candidates FC. The first-part-position-candidate confidence-level calculating unit 330 calculates multiple second confidence levels (the second term on the right side of Equation (3) or Equation (4)) of the first-part position candidates FC so that the longer the distance between the first-part estimated position FP estimated to be the position of the first part in the target image TI and one of the first-part position candidates FC, the lower the confidence level of the first-part position candidate FC. The first-part-position-candidate confidence-level calculating unit 330 adds the weighted first confidence level and the weighted second confidence level for each of the first-part position candidates FC to calculate the first-part-position candidate confidence level FR, which indicates the confidence level of each of the first-part position candidates.

The function of the third-part-position estimating unit 360 will now be described.

The third-part-position estimating unit 360 estimates the position of a third part in a target image TI to calculate a third-part-position estimated position TP. Here, the third-part-position estimating unit 360 estimates the third-part-position estimated position TP from the target image TI and a first-part position FA. This estimation method is provided by the same function as that of the second-part-position estimating unit 120 according to the first embodiment, except that the first-part position, which is an input position, is always a single position.

The third-part-position estimated position TP may include an index indicating deviation from the predicted position, for example, a variance covariance matrix. The method of calculating the variance covariance matrix is the same as the method of calculating the size. That is, the matrix obtained by calculating the weighted sum of the value of the class likelihood vector CV1 for the variance covariance matrix indicating the variation of the learning difference data vectors of each of the classes is applied as an index indicating the variation included in the third-part-position estimated position TP.

The feature value calculation used by the SVR classifiers can be shared by the second-part-position estimating unit 120 and the third-part-position estimating unit 360, although there is a distance in the order of execution. That is, the feature value calculated by the second-part-position estimating unit 120 can be input to the third-part-position estimation unit 360, so that the third-part-position estimating unit 360 can omit the feature value calculation operation, to speed up the overall processing.

Multiple part-position estimation units may be provided in parallel to the third-part-position estimating unit 360, such as a fourth-part-position estimating unit, a fifth-part-position estimating unit, and so on. This is an effective implementation in a region such as the neck where there are multiple succeeding parts. In contrast, the third-part-position estimating unit 360 may not be provided for distal sites, such as a hand or a foot, where there are no succeeding parts.

A portion or the entirety of the image input unit 110, the first-part-position candidate detecting unit 340, the second-part-position estimating unit 120, the first-part-position-candidate confidence-level calculating unit 330, the first-part selecting unit 250, and the third-part-position estimating unit 360 described above can be implemented by, for example, the memory 10 and the processor 11, such as a CPU, that executes the programs stored in the memory 10, as illustrated in FIG. 6A. In other words, the detection device 200 may be implemented by a computer. Such programs may be provided via a network or may be recorded and provided on a recording medium. That is, such programs may be provided as, for example, program products.

A portion or the entirety of the image input unit 110, the first-part-position candidate detecting unit 340, the second-part-position estimating unit 120, the first-part-position-candidate confidence-level calculating unit 330, the first-part selecting unit 250, and the third-part-position estimating unit 360, for example, can be implemented by the processing circuit 12, as illustrated in FIG. 6B.

In other words, the image input unit 110, the first-part-position candidate detecting unit 340, the second-part-position estimating unit 120, the first-part-position-candidate confidence-level calculating unit 330, the first-part selecting unit 250, and the third-part-position estimating unit 360 can be implemented by processing circuitry.

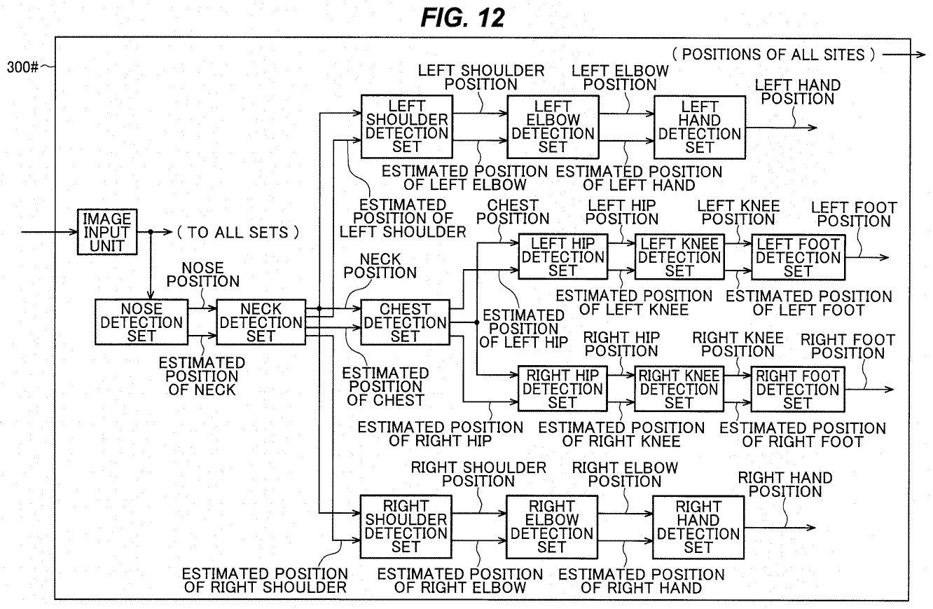

FIG. 12 illustrates an example of the overall configuration of a detection device 300 # serving as a skeletal detection device that performs the processing by the detection device 300 illustrated in FIG. 10 on all parts to be detected in a human skeletal frame.

Here, each block illustrated in FIG. 12 including a character string “set”, such as “neck detection set,” “right shoulder detection set,” “chest detection set,” or “left shoulder detection set,” is constituted by a part output device 301 indicated by the dashed lines in FIG. 10.

Specifically, the part output device 301 including the first-part-position candidate detecting unit 340, the second-part-position estimating unit 120, the first-part-position-candidate confidence-level calculating unit 330, the first-part selecting unit 250, and the third-part-position estimating unit 360 accepts input of a first-part position FA output from a preceding set or a nose coordinate detection set as a second-part position SA, and accepts input of a third-part-position estimated position TP output from the preceding set or the nose coordinate detection set as a first-part estimated position FP, to output the position of a desired part as the first-part position FA and the estimated position of a part detected subsequent to the desired part as the third part estimated position TP.

In other words, a part detection set, represented by a block, can accurately select and output the position of the corresponding site at high speed by using an estimated value of the site to be detected, and using the confidence level based on the gap between the estimated value of a preceding site and the actual value for the accuracy.

Although there is no preceding part for the “nose detection set,” which is the leading block, the first-part-position candidate detecting unit 340 of the third embodiment is operated by inputting “no first-part estimated position FP.” In such a case, the search range cannot be limited, but a nose position candidate can be detected, as described above.

In FIG. 12, the parts to be detected are listed as “nose,” “neck,” “right shoulder,” “right elbow,” “right hand,” “left shoulder,” “left elbow,” “left hand,” “chest,” “right hip,” “right knee,” “right foot,” “left hip,” “left knee,” and “left foot” in a detection order considered appropriate, but such combination and detection order of the parts are mere examples and do not preclude insertion of other parts, skipping of some parts, or changing of the detection order.

Such a detection device 300 # can accurately detect the entire human skeletal frame at high speed.

### Fourth Embodiment

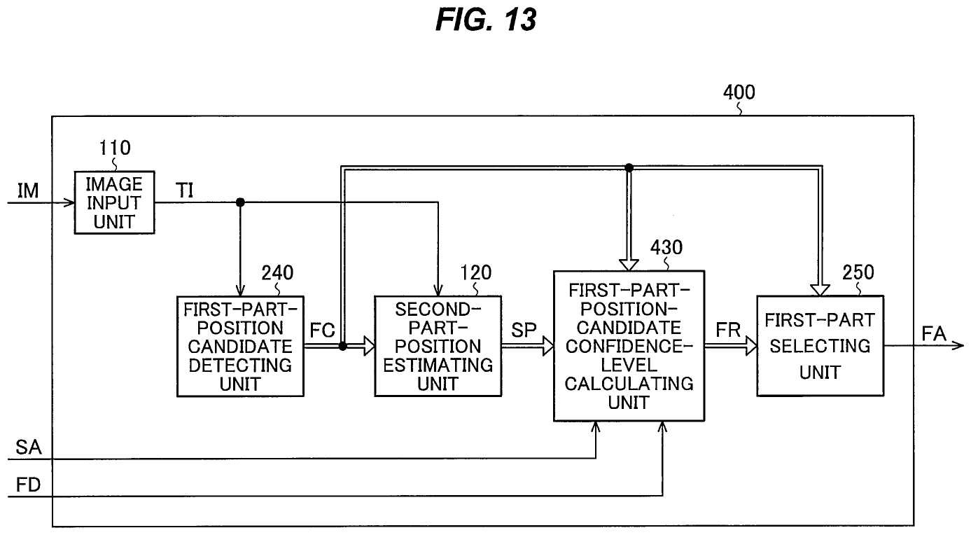

FIG. 13 is a block diagram schematically illustrating the configuration of a detection device 400 according to the fourth embodiment.

The detection device 400 includes an image input unit 110, a first-part-position candidate detecting unit 240, a second-part-position estimating unit 120, a first-part-position-candidate confidence-level calculating unit 430, and a first-part selecting unit 250.

The image input unit 110 and the second-part-position estimating unit 120 of the detection device 400 according to the fourth embodiment are respectively the same as the image input unit 110 and the second-part-position estimating unit 120 of the detection device 100 according to the first embodiment.

However, the image input unit 110 gives a target image TI to the first-part-position candidate detecting unit 240 and the second-part-position estimating unit 120. The second-part-position estimating unit 120 receives a first-part position candidate FC from the first-part-position candidate detecting unit 240 and gives a second-part estimated position SP to the first-part-position-candidate confidence-level calculating unit 430.

The first-part-position candidate detecting unit 240 and the first-part selecting unit 250 of the detection device 400 according to the fourth embodiment are respectively the same as the first-part-position candidate detecting unit 240 and the first-part selecting unit 250 of the detection device 200 according to the second embodiment.

However, the first-part-position candidate detecting unit 240 gives a first-part position candidate FC to the second-part-position estimating unit 120, the first-part-position-candidate confidence-level calculating unit 430, and the first-part selecting unit 250. The first-part selecting unit 250 receives a first-part-position candidate confidence level FR from the first-part-position-candidate confidence-level calculating unit 430.

In the fourth embodiment, the first-part-position-candidate confidence-level calculating unit 430 calculates the first-part-position candidate confidence level FR, which is the confidence level of a first-part position candidate, by using a second-part estimated position SP, a second-part position SA, and a first-part delay position FD. When a multiple number of first-part position candidates FC is input, the same number of second-part estimated positions SP and first-part-position candidate confidence levels FR are output, as in the first and second embodiments.

The first-part delay position FD is a first-part position FA in the past. As an example, when an image IM is a moving image, a first-part position FA in a target image TI of the previous frame, which is another image, is stored in a storage device such as a memory (not illustrated), and the stored value may be input as the first-part delay position FD.

In the first embodiment, the first-part-position candidate confidence level FR is calculated in accordance with the gap between the second-part estimated position SP and the second-part position SA, but in the fourth embodiment, the first-part-position candidate confidence level FR can be calculated by also using the gap between the first-part position candidate FC and the first-part delay position FD.

A specific example of a calculation formula for the first-part-position candidate confidence level FR will be provided below.

When the distance between the first-part position candidate FC and the first-part delay position FD is d_{f,d} pixels, the dimension of a side of the first-part delay position FD is w_{f,d} pixels, the distance threshold used for the first part determined by the designer is d_{f,d,th}, and the weight of the confidence level by the first part determined by the designer is g_{f,d}, the confidence level r can be determined by Equation (5) below.

$$[ Equation 5 ]$$

$$r = {g}_{s , a} exp ( - \frac{( {d}_{s , a} / {w}_{s , a} )}{1.4427 {d}_{s , a , th}} ) + {g}_{f , d} exp ( - \frac{( {d}_{f , d} / {w}_{f , d} )}{1.4427 {d}_{f , d , th}} ) \qquad ( 5 )$$

The first term on the right side of Equation (5) is the same as the right side of Equation (1) in the first embodiment, except that the weight value g_{s,a} is provided as a multiplier. The second term of the right side of Equation (5) is calculated by the same Gaussian function as the first term, except that the target part of the distance calculation is changed from the second part to the first part, and the actual position used for the second part is replaced by a past position.

Equation (5) is an example in which the first-part position candidate FC and the first-part delay position FD are squares.

When the first-part position candidate FC and the first-part delay position FD are rectangles, W_{f,d} is the average of the long side and the short side of the first-part delay position FD.

When each of the first-part position candidate FC and the first-part estimated position FP is coordinates of a point, W_{f,d} may be set to “1.”

When the first-part position coordinates FC and the first-part delay coordinates FD are each not of a point, Equation (6) below can be used by introducing the same idea as Equation (2) in which the difference in the sizes of the parts is also taken into account.

$$[ Equation 6 ]$$

$$\begin{matrix}r = {g}_{s , a} exp ( - \frac{( {d}_{s , a} / {w}_{s , a} )}{1.4427 {d}_{s , a , th}} ) \frac{min ( {w}_{s , a} , {w}_{s , p} )}{max ( {w}_{s , a} , {w}_{s , p} )} \\ + {g}_{f , d} exp ( - \frac{( {d}_{f , d} / {w}_{f , d} )}{1.4427 {d}_{f , d , th}} ) \frac{min ( {w}_{f , d} , {w}_{f , c} )}{max ( {w}_{f , d} , {w}_{f , c} )}\end{matrix} \qquad ( 6 )$$

Where w_{f,c} is the dimension of a side of the first-part position candidate FC.

When the first-part position candidate FC and the first-part delay position FD are rectangles, W_{f,c} is the average of the long side and the short side of the first-part position candidate FC.

As described above, the first-part-position-candidate confidence-level calculating unit 430 according to the fourth embodiment calculates multiple first confidence levels (the first term on the right side of Equation (5) or Equation (6)) of the first-part position candidates FC so that the longer the distance between the second-part position SA, which is the position of the second part in the target image TI, and one of the second-part estimated positions SP, the lower the confidence level of the first-part position candidate FC used for the estimation of the second-part estimated position SP out of the multiple first-part position candidates FC. The first-part-position-candidate confidence-level calculating unit 430 calculates multiple second confidence levels (the second term on the right side of Equation (5) or Equation (6)) of the first-part position candidates FC so that the longer the distance between the first-part delay position FD selected in the past as the first-part position and one of the first-part position candidates FC, the lower the confidence level of the first-part position candidate FC. The first-part-position-candidate confidence-level calculating unit 430 adds the weighted first confidence level and the weighted second confidence level for each of the first-part position candidates FC to calculate the first-part-position candidate confidence level FR, which indicates the confidence level of each of the first-part position candidates FC.

A portion or the entirety of the image input unit 110, the first-part-position candidate detecting unit 340, the second-part-position estimating unit 120, the first-part-position-candidate confidence-level calculating unit 430, the first-part selecting unit 250, and the third-part-position estimating unit 360 described above can be implemented by, for example, the memory 10 and the processor 11, such as a CPU, that executes the programs stored in the memory 10, as illustrated in FIG. 6A. In other words, the detection device 200 may be implemented by a computer. Such programs may be provided via a network or may be recorded and provided on a recording medium. That is, such programs may be provided as, for example, program products.

A portion or the entirety of the image input unit 110, the first-part-position candidate detecting unit 340, the second-part-position estimating unit 120, the first-part-position-candidate confidence-level calculating unit 430, the first-part selecting unit 250, and the third-part-position estimating unit 360, for example, can be implemented by the processing circuit 12, as illustrated in FIG. 6B.

In other words, the image input unit 110, the first-part-position candidate detecting unit 340, the second-part-position estimating unit 120, the first-part-position-candidate confidence-level calculating unit 430, the first-part selecting unit 250, and the third-part-position estimating unit 360 can be implemented by processing circuitry.

In the above, the first-part-position candidate confidence level FR is calculated by using the first-part position FA at a time point in the past, but by further increasing the number of terms, the first-part-position candidate confidence level FR can be calculated by using the first-part positions FA at two or more time points in the past.

The equations presented here are mere examples, and the confidence level may be calculated using an exponential function, a trigonometric function, a logarithmic function, a hyperbolic function, a step function, a delta function, or other mathematical functions including a first-order polynomial, a second-order polynomial, a higher-order polynomial, a square root or a cube root, or a mathematical formula combining these functions.

By using the method explained in the fourth embodiment, the past information of the first part can be added to the reference of the confidence level of the first part, and the confidence level r corresponding to the first-part-position candidate confidence level FR can be calculated more accurately.

### Fifth Embodiment

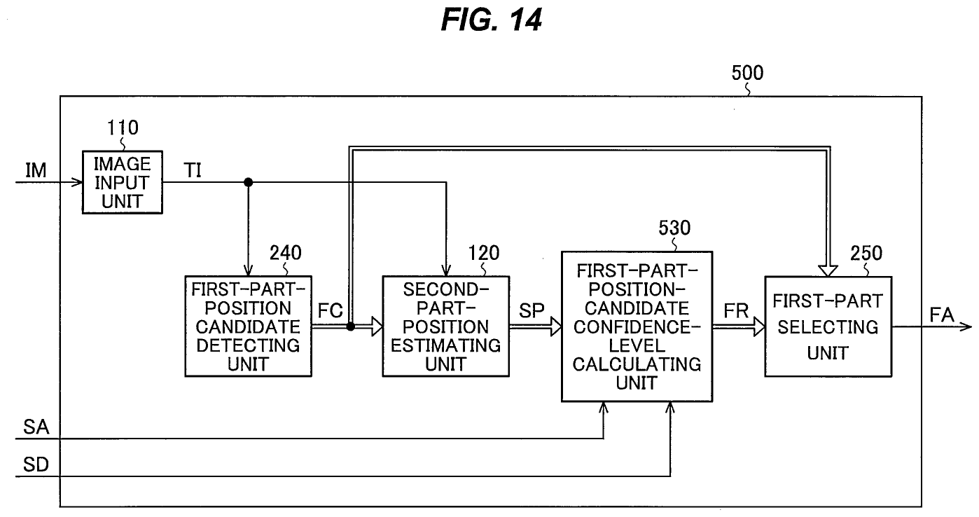

FIG. 14 is a block diagram schematically illustrating the configuration of a detection device 500 according to the fifth embodiment.

The detection device 500 includes an image input unit 110, a first-part-position candidate detecting unit 240, a second-part-position estimating unit 120, a first-part-position-candidate confidence-level calculating unit 530, and a first-part selecting unit 250.

The image input unit 110 and the second-part-position estimating unit 120 of the detection device 500 according to the fifth embodiment are respectively the same as the image input unit 110 and the second-part-position estimating unit 120 of the detection device 100 according to the first embodiment.

However, the image input unit 110 gives a target image TI to the first-part-position candidate detecting unit 240 and the second-part-position estimating unit 120.

The first-part-position candidate detecting unit 240 and the first-part selecting unit 250 of the detection device 500 according to the fifth embodiment are respectively the same as the first-part-position candidate detecting unit 240 and the first-part selecting unit 250 of the detection device 200 according to the second embodiment.

However, the first-part selecting unit 250 receives a first-part-position candidate confidence level FR from the first-part-position-candidate confidence-level calculating unit 530.

In the fifth embodiment, the first-part-position-candidate confidence-level calculating unit 530 calculates a first-part-position candidate confidence level FR, which is a confidence level of a first-part position candidate, by using a second-part estimated position SP, a second-part position SA, and a second-part delay position SD. When a multiple number of first-part position candidates FC are input, the same number of second-part estimated positions SP and first-part-position candidate confidence levels FR are output, as in the first to fourth embodiments.

The second-part delay position SD is a second-part position SA in the past. As an example, when an image IM is a moving image, a second-part position SA in a target image TI of the previous frame is stored in a storage device such as a memory (not illustrated), and the stored value may be input as the second-part delay position SD.

In the first embodiment, the first-part-position candidate confidence level FR is calculated in accordance with the gap between the second-part estimated position SP and the second-part position SA, but in the fifth embodiment, the first-part-position candidate confidence level FR can be calculated by also using the gap between the second-part estimated position SP and the second-part delay position SD.

A specific example of a calculation formula for the first-part-position candidate confidence level FR will be provided below.

When the distance between the second-part estimated position SP and the second-part position SA is d_{s,a} pixels, the dimension of a side of the second part is w_{s,a} pixels, the distance threshold used for the second part determined by the designer is d_{s,a,th}, the distance between the second-part estimated position SP and the second-part delay position SD is d_{s,d} pixels, the dimension of a side of the second-part delay position SD is W_{s,d} pixels, the distance threshold used for the first part determined by the designer is d_{s,d,th}, the weight of the confidence level by the second-part position SA determined by the designer is g_{s,a}, and the weight of the confidence level by the second-part delay position SD determined by the designer is f_{s,d}, the confidence level r can be determined by Equation (7) below.

$$[ Equation 7 ]$$

$$r = {g}_{s , a} exp ( - \frac{( {d}_{s , a} / {w}_{s , a} )}{1.4427 {d}_{s , a , th}} ) + {g}_{s , d} exp ( - \frac{( {d}_{s , d} / {w}_{s , d} )}{1.4427 {d}_{s , d , th}} ) \qquad ( 7 )$$

Equation (7) is an example in which the second-part estimated position SP and the second-part delay position SD are squares.

When the second-part estimated position SP and the second-part delay position SD are rectangles, W_{s,d} is the average of the long side and the short side of the second-part delay position SD.

When each of the second-part estimated position SP and the second-part delay position SD is coordinates of a point, W_{s,d} may be set to “1.”

When the second-part estimated position SP and the second-part delay position SD are each not coordinates of a point, Equation (8) below can be used by introducing the same idea as Equation (2) in which the gap in the sizes of the parts is also taken into account.

$$[ Equation 8 ]$$

$$\begin{matrix}r = {g}_{s , a} exp ( - \frac{( {d}_{s , a} / {w}_{s , a} )}{1.4427 {d}_{s , a , th}} ) {( \frac{min ( {w}_{s , a} , {w}_{s , p} )}{max ( {w}_{s , a} , {w}_{s , p} )} )}^{\frac{1}{{d}_{s , a , th}}} \\ + {g}_{s , d} exp ( - \frac{( {d}_{s , d} / {w}_{s , d} )}{1.4427 {d}_{s , d , th}} ) {( \frac{min ( {w}_{s , d} , {w}_{s , p} )}{max ( {w}_{s , d} , {w}_{s , p} )} )}^{\frac{1}{{d}_{s , d , th}}}\end{matrix} \qquad ( 8 )$$

Where w_{s,d} is the dimension of a side of the second-part delay position SD.

When the second-part estimated position SP and the second-part delay position SD are rectangles, W_{s,d} is the average of the long side and the short side of the second-part delay position SD.

In Equation (8), to increase the tolerance to the gap in the sizes of the parts when d_{s,a,th} is large, 1/d_{s,d,th} is provided.

As described above, the first-part-position-candidate confidence-level calculating unit 530 according to the fifth embodiment calculates multiple first confidence levels (the first term on the right side of Equation (7) or Equation (8)) of the first-part position candidates FC so that the longer the distance between the second-part position SA, which is the position of the second part in the target image TI, and one of the second-part estimated positions SP, the lower the confidence level of the first-part position candidate FC used for the estimation of the second-part estimated position SP out of the multiple first-part position candidates FC. The first-part-position-candidate confidence-level calculating unit 530 calculates second confidence levels (the second term on the right side of Equation (7) or Equation (8)) of the first-part position candidates FC so that the longer the distance between the second-part delay position SD, which is the position used as the second-part position SA in the past, and one of the second-part estimated positions SP, the lower the confidence level of the first-part position candidate FC used for the estimation of the second-part estimated position SP out of the multiple first-part position candidates FC. The first-part-position-candidate confidence-level calculating unit 530 calculates the first-part-position candidate confidence levels FR, each of which indicates the confidence level of each of the first-part position candidates FC by weighting and adding the first confidence level and the second confidence level of each of the first-part position candidates FC.

A portion or the entirety of the image input unit 110, the first-part-position candidate detecting unit 240, the second-part-position estimating unit 120, the first-part-position-candidate confidence-level calculating unit 530, and the first-part selecting unit 250 described above can be implemented by, for example, the memory 10 and the processor 11, such as a CPU, that executes the programs stored in the memory 10, as illustrated in FIG. 6A. In other words, the detection device 200 may be implemented by a computer. Such programs may be provided via a network or may be recorded and provided on a recording medium. That is, such programs may be provided as, for example, program products.

A portion or the entirety of the image input unit 110, the first-part-position candidate detecting unit 240, the second-part-position estimating unit 120, the first-part-position-candidate confidence-level calculating unit 530, and the first-part selecting unit 250, for example, can be implemented by the processing circuit 12, as illustrated in FIG. 6B.

In other words, the image input unit 110, the first-part-position candidate detecting unit 240, the second-part-position estimating unit 120, the first-part-position-candidate confidence-level calculating unit 530, and the first-part selecting unit 250 can be implemented by processing circuitry.

In the above, the first-part-position candidate confidence level FR is calculated by using the second-part position SA at a time point in the past, but by further increasing the number of terms, the first-part-position candidate confidence level FR can be calculated by using the second-part positions SA at two or more time points in the past.

The equations presented here are mere examples, and the confidence level may be calculated using an exponential function, a trigonometric function, a logarithmic function, a hyperbolic function, a step function, a delta function, or other mathematical functions including a first-order polynomial, a second-order polynomial, a higher-order polynomial, a square root or a cube root, or a mathematical formula combining these functions.

By using the method explained in the fifth embodiment, the past information of the second-part position can be taken into consideration in the calculation of the confidence level of the first part, and the confidence level r can be calculated more accurately.

When a second-part position cannot be found in the current frame, the first-part-position candidate confidence level FR can be calculated by using only the second term of the right side of Equation (6) or Equation (8).

### Sixth Embodiment

As illustrated in FIG. 1, a detection device 600 according to the sixth embodiment includes an image input unit 110, a second-part-position estimating unit 620, and a first-part-position-candidate confidence-level calculating unit 130.

The image input unit 110 and the first-part-position-candidate confidence-level calculating unit 130 of the detection device 600 according to the sixth embodiment are respectively the same as the image input unit 110 and the first-part-position-candidate confidence-level calculating unit 130 of the detection device 100 according to the first embodiment.

However, the first-part-position-candidate confidence-level calculating unit 130 according to the sixth embodiment acquires a second-part estimated position SP from the second-part-position estimating unit 620.

The second-part-position estimating unit 620 calculates the second-part estimated position SP by using a target image TI and a first-part position candidate FC.

In the sixth embodiment, the second-part estimated position SP is calculated on the basis of the likelihood that the first part belongs to each of the classes and the relative positional relationship between the first part and the second part in each of the classes by using predetermined classes based on a pre-recorded feature value of the first part.

For example, the second-part-position estimating unit 620 can calculate the second-part estimated position SP by using, for example, a method using a neural network, a method using an SVM or support vector regression (SVR), a method using regression analysis, or a method using a genetic algorithm or genetic programming.

FIG. 3 is a block diagram illustrating an example configuration of the second-part-position estimating unit 620 using SVR. The second-part-position estimating unit 620 includes an SVR classifier 621 and a second-part-position estimator 122.

The second-part-position estimator 122 of the second-part-position estimating unit 620 according to the sixth embodiment is the same as the second-part-position estimator 122 of the second-part-position estimating unit 120 according to the first embodiment.

However, the second-part-position estimator 122 according to the sixth embodiment acquires a class likelihood vector CV6 from the SVR classifier 621.

The SVR classifier 621 uses SVR to analyze the portion of the target image TI indicated by a first-part position candidate FC, specifies a class likelihood vector CV6, and gives the class likelihood vector CV6 to the second-part-position estimator 122.

The SVR classifier 621 according to the sixth embodiment is different from the SVR classifier 121 according to the first embodiment in the method of determining the class to which the learning data belongs.

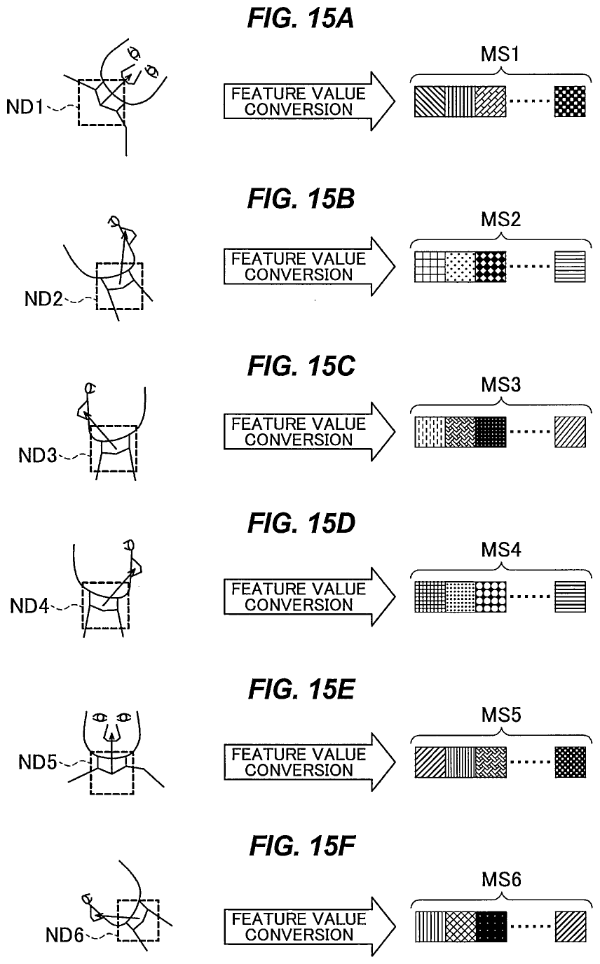

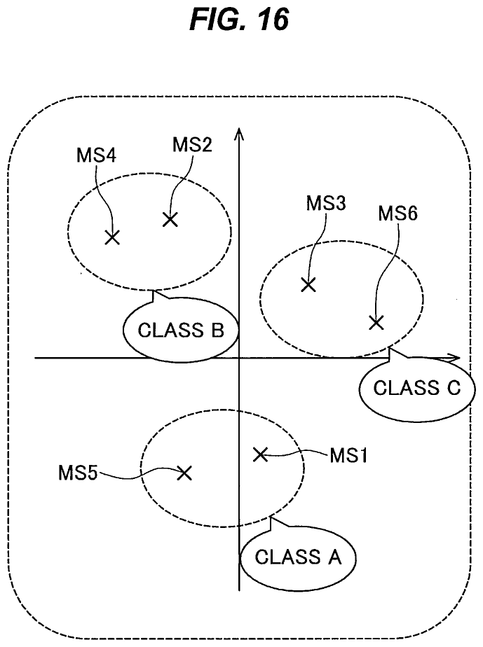

FIGS. 15 and 16 are schematic diagrams illustrating the method of determining the class to which the learning data belongs according to the sixth embodiment.

As illustrated in FIGS. 15A to 15F, it is presumed that the SVR classifier 621 has acquired a pre-recorded first part group or a first learning part group having various kinds of neck learning data items ND1 to ND6.

In general, learning data is converted into some kind of feature value to construct a model. The feature values commonly used include feature values of HOG, LBP, Haar-Like features, and scale invariant feature transformation (SIFT); any of these feature values can be applied to the present embodiment.

Here, the learning data items ND1 to ND6 are respectively converted into feature values MS1 to MS6, as respectively illustrated in FIGS. 15A to 15F.

FIG. 16 is a schematic diagram illustrating an example of the distribution of the feature values MS1 to MS6 in a feature value space.

In FIG. 16, a two-dimensional distribution is used for illustrative purposes, but the feature values are typically high-dimensional vectors.

Before the learning process, the feature values MS1 to MS6 mapped in the feature value space are clustered through a certain method. Examples of the method for clustering include a method of manually classifying learning samples one by one, a method of manually setting a hyperplane for separating the feature value space, and an unsupervised learning method; however, since these methods are known, they will not be described here.

The unsupervised learning methods include the k-means method, the self-organizing map (SOM) method, and the Gaussian mixture model (GMM) method.

FIG. 16 illustrates an example in which the feature values MS1 and MS5 relatively close to each other in the feature value space constitute a class A, the feature values MS2 and MS4 constitute a class B, and the feature values MS3 and MS6 constitute a class C. It is considered that the learning data whose original appearance is similar have similar feature value in the feature value space, and the possibility of belonging to the same class increases.

Such classification has the advantage of an improvement in the degree of separation between classes in the feature value space. However, in the learning data of each class used for estimation, there is a disadvantage in that the variance of the learning-data difference vector, which is the difference between the coordinate value that is the value of the first-part position and the coordinate value that is the value of the second-part position, becomes large, i.e., there is a possibility that the degree of separation of the learning data of each class deteriorates; and the advantage and the disadvantage are in a trade-off relationship. Thus, which of the classification described in the first embodiment and the classification described in the sixth embodiment is better depends on the situation.

In any case, the SVR classifier 621 outputs the likelihood of each class set in this way as a vector CV6 and gives the vector CV6 to the second-part-position estimator 122.

As described above in the sixth embodiment, the classes are preliminarily classified on the basis of the feature values of the first learning part group, which is a pre-recorded first part group having multiple parts each corresponding to the first part. The second-part estimated positions SP are each calculated on the basis of the likelihood of the first-part position candidates FC belonging to the classes and the statistics value of the relative positional relationship between the first learning part group and the second learning part group in each of the classes, when the second learning part group is a pre-recorded second part group having multiple parts corresponding to the second part.

### Seventh Embodiment

As illustrated in FIG. 1, a detection device 700 according to the seventh embodiment includes an image input unit 110, a second-part-position estimating unit 720, and a first-part-position-candidate confidence-level calculating unit 130.

The image input unit 110 and the first-part-position-candidate confidence-level calculating unit 130 of the detection device 700 according to the seventh embodiment are respectively the same as the image input unit 110 and the first-part-position-candidate confidence-level calculating unit 130 of the detection device 100 according to the first embodiment.

However, the first-part-position-candidate confidence-level calculating unit 130 according to the seventh embodiment receives a second-part estimated position SP from the second-part-position estimating unit 720.

The second-part-position estimating unit 720 calculates a second-part estimated position SP by using a target image TI and a first-part position candidate FC.

In the seventh embodiment, the second-part estimated position SP is calculated on the basis of the likelihood that the first part belongs to each of the classes and the relative positional relationship between the first part and the second part in each of the classes by using predetermined classes based on a pre-recorded feature value of the first part.

For example, the second-part-position estimating unit 720 can calculate the second-part estimated position by using, for example, a method using a neural network, a method using an SVM or support vector regression (SVR), a method using regression analysis, or a method using a genetic algorithm or genetic programming.

FIG. 3 is a block diagram illustrating an example configuration of the second-part-position estimating unit 720 using SVR. The second-part-position estimating unit 720 includes an SVR classifier 721 and a second-part-position estimator 122.

The second-part-position estimator 122 of the second-part-position estimating unit 720 according to the seventh embodiment is the same as the second-part-position estimator 122 of the second-part-position estimating unit 120 according to the first embodiment.

However, the second-part-position estimator 122 according to the seventh embodiment acquires a class likelihood vector CV7 from the SVR classifier 721.

The SVR classifier 721 uses SVR to analyze the portion of the target image TI indicated by a first-part position candidate FC, specifies a class likelihood vector CV7, and gives the class likelihood vector CV7 to the second-part-position estimator 122.

The SVR classifier 721 according to the seventh embodiment is different from the SVR classifier 121 according to the first embodiment in the method of determining the class to which the learning data belongs.

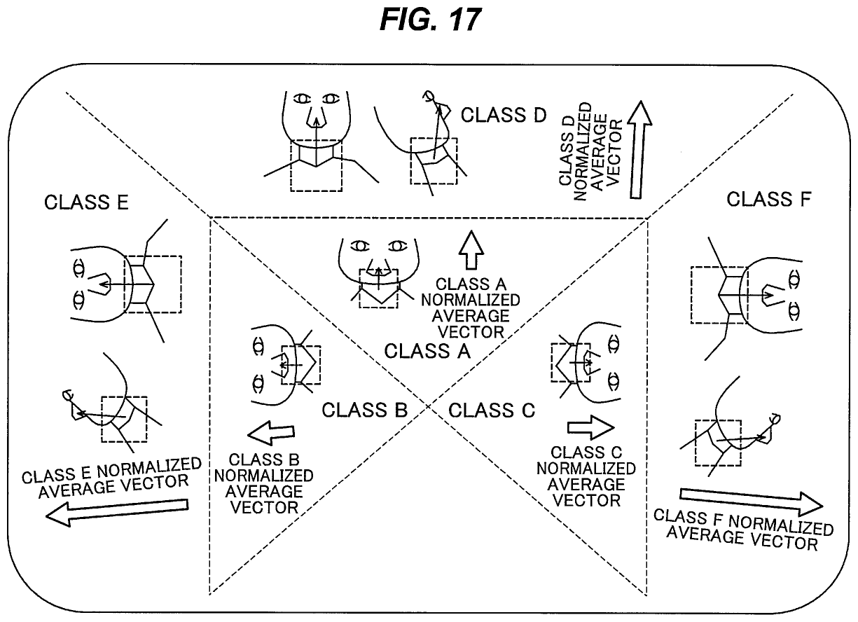

FIG. 17 is a schematic diagram illustrating a method of determining the class to which learning data belongs according to the seventh embodiment when the first part is the neck and the second part is the nose.

In the first embodiment, the classification is based only on the direction of the learning-data difference vector, that is, the direction from the neck to the nose, but in the seventh embodiment, the classification is based on two criteria: the direction of the learning-data difference vector, that is, the direction from the neck to the nose, and the length of the learning-data difference vector, that is, the distance from the neck to the nose.

Specifically, Class A is a class in which the direction from the neck to the nose is upward, and the distance is short. Class B is a class in which the direction from the neck to the nose is leftward, and the distance is short. Class C is a class in which the direction from the neck to the nose is rightward, and the distance is short. Class D is a class in which the direction from the neck to the nose is upward, and the distance is long. Class E is a class in which the direction from the neck to the nose is leftward, and the distance is long. Class F is a class in which the direction from the neck to the nose is rightward, and the distance is long.

Here, the distance between the nose and the neck in the target image TI varies even though there is substantially no change in the distance between the neck and the nose in the real space because, when a two-dimensional camera is used, the directional relationship between the optical axis of the camera and the straight line from the neck to the nose in the real space varies. Specifically, when the optical axis of the camera and the straight line from the neck to the nose are in a substantially vertical relationship, the distance between the neck and the nose in the target image TI increases, and when the optical axis of the camera and the straight line from the neck to the nose are in a substantially parallel relationship, the distance between the neck and the nose in the target image TI decreases.

Such a classification strategy is particularly effective in classifying learning models of parts having large degrees of freedom of movement, such as the elbow. In other words, the natural part adjacent to the elbow is the hand, the wrist, or the shoulder; but since the forearm and upper arm generally have a high degree of freedom of movement, the distance between the forearm or the upper arm and the elbow on a two-dimensional screen varies greatly, so that the classification strategy described in the seventh embodiment is effective.

The classification illustrated in FIG. 17 is an example for explanation, and does not exclude the addition of a diagonal or downward direction or the distance divisions increased to three or more.

As described above in the seventh embodiment, the classes are preliminarily classified on the basis of the direction of the learning-data difference vectors and the length of the learning-data difference vector, when a pre-recorded first part group or first learning part group has parts corresponding to the first part, a pre-recorded second part group or second learning part group has parts corresponding to the second part, and a learning-data difference vector represents the difference between a coordinate value of a part in the first learning part group and a coordinate value of a part in the second learning part group. The second-part estimated positions SP are each calculated on the basis of the likelihood that the corresponding first-part position candidate FC belongs to each of the classes and the statistics value of the learning-data difference vector and the length of the learning-data difference vector.

### DESCRIPTION OF REFERENCE CHARACTERS

100, 200, 300, 400, 500, 600, 700 detection device; 110 image input unit; 120, 620, 720 second-part-position estimating unit; 121, 621, 721 SVR classifier; 122 second-part position estimator; 130, 330, 430, 530 first-part-position-candidate confidence-level calculating unit; 240, 340 first-part-position candidate detecting unit; 250 first-part selecting unit; 360 third-part-position estimating unit.

1.-23. (canceled)

24. An information processing device comprising:
processing circuitry
to calculate a plurality of second-part estimated positions by estimating a position of a second part in a target image from a plurality of first-part position candidates, each of the first-part position candidates being a candidate of a position of a first part in the target image; and
to calculate a plurality of first-part-position candidate confidence levels indicating confidence levels of the first-part position candidates.

25. The information processing device according to claim 24, wherein the processing circuitry calculates the first-part-position candidate confidence levels so that the longer the distance between a second-part position and one of the second-part estimated positions, the lower the confidence level of the first-part position candidate used for the estimation of the one of the second-part estimated position out of the first-part position candidates, the second-part position being a position of the second part in the target image.

26. The information processing device according to claim 24, wherein the processing circuitry detects the first-part position candidates from the target image.

27. The information processing device according to claim 24, wherein the processing circuitry uses a first-part estimated position to specify a partial region of the target image and detects the first-part position candidates from the specified region, the first-part estimated position being an estimated position of the first part.

28. The information processing device according to claim 24, wherein the processing circuitry selects one of the first-part position candidates as a first-part position from the first-part-position candidates in accordance with the first-part-position candidate confidence levels.

29. The information processing device according to claim 28, wherein the processing circuitry calculates a third-part estimated position by estimating a position of a third part in the target image from the first-part position.

30. The information processing device according to claim 24, wherein the processing circuitry calculates a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image, calculates a second confidence level of each of the first-part position candidates so that the longer the distance between a first-part estimated position estimated to be a position of the first part in the target image and one of the first-part position candidates, the lower the confidence level of the one of the first-part position candidates, and calculates the first-part-position candidate confidence levels by weighting and adding the first confidence level and the second confidence level of each of the first-part position candidates.

31. The information processing device according to claim 24, wherein the processing circuitry calculates a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image, calculates a second confidence level of each of the first-part position candidates so that the longer the distance between a first-part delay position selected to be a position of the first part in the past and one of the first-part position candidates, the lower the confidence level of the one of the first-part position candidates, and calculates the first-part-position candidate confidence levels by weighting and adding the first confidence level and the second confidence level of each of the first-part position candidates.

32. The information processing device according to claim 24, wherein the processing circuitry calculates a first confidence level of each of the first-part position candidates so that the longer the distance between a second-part position and one of the second-part estimated positions, the lower the confidence level of the first-part position candidate used for the estimation of the one of the second-part estimated position out of the first-part position candidates, the second-part position being the position of a second part in the target image, calculates a second confidence level of each of the first-part position candidates so that the longer the distance between a first-part delay position used as the first-part position in the past and one of the first-part estimated positions, the lower the confidence level of the one of the first-part estimated positions, and calculates the first-part-position candidate confidence levels by weighting and adding the first confidence level and the second confidence level of each of the first-part position candidates.

33. The information processing device according to claim 24, wherein the processing circuitry calculates the second-part estimated positions from vectors calculated by adding learning-data difference vectors corresponding to preliminarily classified classes to which the first-part position candidates belong and the first-part position candidates in accordance with a likelihood of the first-part position candidates belonging to the classes.

34. The information processing device according to claim 33, wherein,
the classes are preliminarily classified based on a direction of the learning-data difference vector, when a first learning part group is a pre-recorded first part group having parts each corresponding to the first part, a second learning part group is a pre-recorded second part group having parts each corresponding to the second part, and the learning-data difference vector is a difference between a coordinate value of a part in the first learning part group and a coordinate value of a part in the second learning part group corresponding to the part in the first learning part group, and
the second-part estimated positions are each calculated based on a likelihood that the corresponding first-part position candidate belongs to each of the classes and a statistics value of the learning-data difference vector for each of the classes.

35. The information processing device according to claim 33, wherein,
the classes are preliminarily classified based on a feature value of a first learning part group, the first learning part group being a pre-recorded first part group having multiple parts each corresponding to the first part, and
the second-part estimated positions are each calculated based on a likelihood of each of the first-part position candidates belonging to each of the classes and a statistics value of a relative positional relationship between the first learning part group and the second learning part group in each of the classes, when the second learning part group is a pre-recorded second part group having multiple parts corresponding to the second part.

36. The information processing device according to claim 33, wherein the classes are preliminarily classified based on a direction of the learning-data difference vector and a length of the learning-data difference vector, when a first learning part group is a pre-recorded first part group having parts corresponding to the first part, a second learning part group is a pre-recorded second part group having parts corresponding to the second part, and the learning-data difference vector is the difference between a coordinate value of a part in the first learning part group and a coordinate value of a part in the second learning part group, and the second-part estimated positions are each calculated based on a likelihood that the corresponding first-part position candidate belongs to each of the classes and a statistics value of the learning-data difference vector and the length of the learning-data difference vector.

37. The information processing device according to claim 33, wherein the likelihood that the corresponding to first-part position candidate belongs to each of the classes is calculated by using support vector regression.

38. The information processing device according to claim 33, wherein the likelihood that the corresponding to first-part position candidate belongs to each of the classes is calculated by using a neural network.

39. The information processing device according to claim 33, wherein the likelihood that the corresponding to first-part position candidate belongs to each of the classes is calculated by using a genetic algorithm.

40. A non-transitory computer-readable storage medium storing a program that causes a computer to execute processes comprising:
calculating a plurality of second-part estimated positions by estimating a position of a second part in a target image from a plurality of first-part position candidates, each of the first-part position candidates being a candidate of a position of a first part in the target image; and
calculating a plurality of first-part-position candidate confidence levels indicating confidence levels of the first-part position candidates.

41. An information processing method comprising:
calculating a plurality of second-part estimated positions by estimating a position of a second part in a target image from a plurality of first-part position candidates, each of the first-part position candidates being a candidate of a position of a first part in the target image; and
calculating a plurality of first-part-position candidate confidence levels indicating confidence levels of the first-part position candidates.
